(19) United States
(12) Patent Application Publication
(10) Pub. No.: US 2013/0326499 A1
(43) Pub. Date: Dec. 5, 2013

(54) AUTOMATICALLY INSTALLING AND REMOVING RECOMMENDED APPLICATIONS

(71) Applicants: David Mowatt, Dalkey (IE); Terry Farrell, Mount Merrion (IE); David Åhs, Ballsbridge (IE)

(72) Inventors: David Mowatt, Dalkey (IE); Terry Farrell, Mount Merrion (IE); David Åhs, Ballsbridge (IE)

(73) Assignee: Microsoft Corporation, Redmond, WA (US)

(21) Appl. No.: 13/485,847

(22) Filed: May 31, 2012

(51) Int. Cl. G06F 9/445

(52) U.S. Cl. 717/177; 717/176

(57) ABSTRACT

Concepts and technologies are described herein for automatically installing and removing recommended applications. In accordance with some of the concepts and technologies disclosed herein, a marketplace server computer determines a recommended application for user, adds the recommended application to an entitlement associated with the user, and sends the recommended application along with instructions to automatically install the recommended application to a user device associated with the user. The installation of the recommended application might be part of a continual installation and removal of recommended applications.

### BACKGROUND

In recent years, the software industry has begun to undergo a shift from the distribution of software applications on physical media, such as CD and DVD, to the distribution of software applications through services that facilitate the download of software from the Internet. Software download services are typically accessed through a Web-based marketplace and/or through a stand-alone marketplace application installed on an end user's computer or other computing device, such as a smart phone. These marketplaces often organize available applications according to category and provide search functionality to enable users to find, download, and install applications.

Typically, a user must visit a marketplace, browse, and select applications before installing the applications one-by-one. During the marketplace browsing experience, the user may see a selection of recommended and/or featured applications, but each application must still be installed individually.

It is with respect to these and other considerations that the disclosure made herein is presented.

### SUMMARY

Concepts and technologies are described herein for automatically installing and removing recommended applications. In accordance with some of the concepts and technologies disclosed herein, a marketplace server computer determines a recommended application for user, adds the recommended application to an entitlement associated with the user, and sends the recommended application along with instructions to automatically install the recommended application to a user device associated with the user.

In some embodiments, the recommended application is determined based upon an application recommendation for every user of an application marketplace provided by the marketplace server computer. In some embodiments, the recommended application is determined based upon information specific to the user, such as context information, application download history information, application purchase history information, and/or application usage information. In some embodiments, the recommended application is determined based upon an application recommendation for a group of users of an application marketplace provided by the marketplace server computer. In some embodiments, the recommended application is determined based upon which previous automatically installed recommended applications were used. In some embodiments, a recommended application is recommended based upon the manufacturer of the user device.

In some embodiments, the marketplace server computer determines a new recommended application for the user, adds the new recommended application to the entitlement associated with the user, and sends the new recommended application along with instructions to install the new recommended application to the user device. In these embodiments, the instructions to install the new recommended application may also include instructions to uninstall the recommended application such that the new recommended application replaces the recommended application on the user device. In some embodiments, the user device polls a central entitlement store to acquire recommended applications. In these embodiments, the recommend applications are made available on all devices that connect to the entitlement store.

In some embodiments, the marketplace server computer tracks a usage of the recommended application, determines that the usage of the recommended application is below a usage threshold, and, in response to determining that the usage of the recommended application is below the usage threshold, removes the recommended application from the entitlement associated with the user and sends instructions to uninstall the recommended application to the user device. In some embodiments, the marketplace server computer receives tracks the usage of the recommended application by receiving feedback from the user device. In some embodiments, the marketplace server computer also determines that the uninstalled recommended application should be replaced and, in response, determines a new recommended application for the user, adds the new recommended application to the entitlement associated with the user, and sends the new recommended application along with instructions to automatically install the new recommended application to the user device. In some embodiments, the recommended application is automatically uninstalled from all the user devices that are configured to poll an entitlement store.

In some embodiments, the marketplace server computer receives an uninstall notification from the user device and, in response, determines that the uninstalled recommended application should be replaced. In response to determining that the uninstalled recommended application should be replaced, the marketplace server computer determines a new recommended application for the user, adds the new recommended application to the entitlement associated with the user, and sends the new recommended application along with instructions to automatically install the new recommended application to the user device.

It should be appreciated that the above-described subject matter may be implemented as a computer-controlled apparatus, a computer process, a computing system, or as an article of manufacture such as a computer-readable storage medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a diagram illustrating an illustrative operating environment for implementing various embodiments presented herein.

FIG. 2 is a flow diagram illustrating aspects of a method for automatically installing recommended applications, according to an illustrative embodiment.

FIG. 3 is a flow diagram illustrating aspects of another method for automatically installing recommended applications, according to an illustrative embodiment.

FIGS. 4A-4C are flow diagrams illustrating aspects of various methods for uninstalling and replacing recommended applications, according to illustrative embodiments.

FIG. 5 is a computer architecture diagram illustrating illustrative computer hardware and software architecture for a computing system capable of implementing aspects of the embodiments presented herein.

FIG. 6 is a diagram illustrating a distributed computing environment capable of implementing aspects of the embodiments presented herein.

FIG. 7 is a computer architecture diagram illustrating a computing device architecture capable of implementing aspects of the embodiments presented herein.

### DETAILED DESCRIPTION

The following detailed description is directed to concepts and technologies for automatically installing and removing recommended applications. In accordance with some of the concepts and technologies disclosed herein, a marketplace server computer determines a recommended application for user, adds the recommended application to an entitlement associated with the user, and sends the recommended application along with instructions to automatically install the recommended application to a user device associated with the user.

While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

In the following detailed description, references are made to the accompanying drawings that form a part hereof, and in which are shown by way of illustration specific embodiments or examples. Referring now to the drawings, in which like numerals represent like elements throughout the several figures, aspects of a computing system, computer-readable storage medium, and computer-implemented methodology for automatically installing and removing recommended applications will be presented.

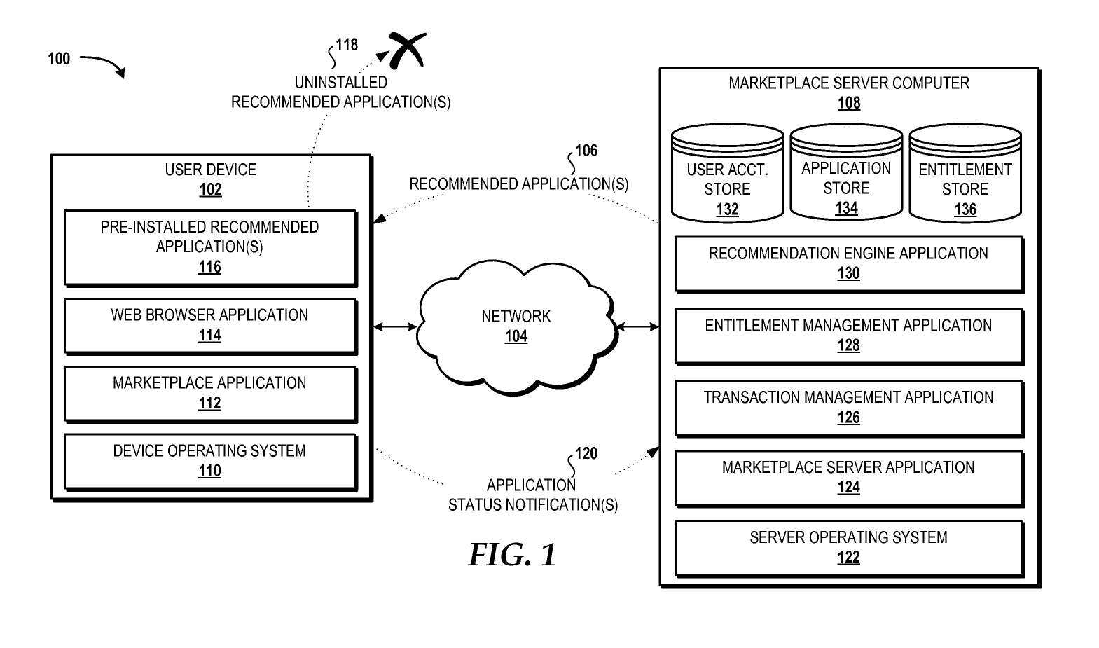

Referring now to FIG. 1, aspects of one operating environment 100 for various embodiments presented herein will be described. The operating environment 100 shown in FIG. 1 includes a user device 102 operating on or in communication with a network 104 to download one or more recommended applications 106 from a marketplace server computer 108. According to embodiments disclosed herein, instead of a user of the user device 102 having to search an application marketplace provided by the marketplace server computer 108 for the recommended applications 106 and proceed through steps to select, download, and install each of the recommended applications 106 one-by-one, the recommended applications 106 are automatically downloaded and installed on the user device 102. In this manner, the need for the user to have to manually seek out, download, and install the recommended applications 106 is eliminated.

The user device 102 may be a personal computer (“PC”), desktop computer, laptop computer, tablet computer, notebook computer, smartphone, personal digital assistant (“PDA”), electronic-book reader, game console, set-top box, consumer electronics device, server computer, or any other type of computing device configured to perform various operations described herein. The network 104 may be an internet, the Internet, an intranet, or an extranet. Access to the network 104 may be provided via one or more wired or wireless access networks (not shown), as will be understood by those skilled in the art.

The user device 102 is configured to execute a device operating system 110 and one or more application programs such as, in the illustrated embodiment, a marketplace application 112, a web browser application 114, and one or more pre-installed recommended applications 116. The device operating system 110 is a computer program for controlling the operation of the user device 102. The application programs are executable programs configured to execute on top of the device operating system 110 to provide various functionality described below.

The marketplace application 112 is an application program through which a user can access an application marketplace provided by the marketplace server computer 108 to obtain marketplace content, such as the recommended applications 106. The marketplace application 110, in some embodiments, is a marketplace client application installed on the user device 102 that provides a graphical user interface (“GUI”) through which a user can browse marketplace content, search for marketplace content, download marketplace content, manage marketplace content, create and manage user accounts, read reviews on marketplace content, and otherwise interact with the application marketplace.

The web browser application 114 is an application program through which a user can access information resources on the Web via the network 104. In some embodiments, the web browser application 114 allows a user to access an application marketplace website hosted by or for the marketplace server computer 108. The marketplace website may provide a web-based GUI through which a user can browse marketplace content, search for marketplace content, download marketplace content, manage marketplace content, create and manage user accounts, read reviews on marketplace content, and otherwise interact with the application marketplace.

The pre-installed recommended applications 116 include the recommended applications 106 that have been downloaded and are currently installed on the user device 102. In some embodiments, the pre-installed recommended applications 116 include applications such as, but not limited to, a word processing application, spreadsheet application, presentation application, drawing application, photography application, design application, video game application, music application, video application, and/or a collaboration application. In some embodiments, the pre-installed recommended applications 116 include MICROSOFT WORD, available from Microsoft Corporation of Redmond, Wash.; MICROSOFT EXCEL, available from Microsoft Corporation of Redmond, Wash.; MICROSOFT POWERPOINT, available from Microsoft Corporation of Redmond, Wash.; MICROSOFT VISIO, available from Microsoft Corporation of Redmond, Wash.; MICROSOFT PROJECT, available from Microsoft Corporation of Redmond, Wash.; MICROSOFT OUTLOOK, available from Microsoft Corporation of Redmond, Wash.; and/or MICROSOFT SHAREPOINT, available from Microsoft Corporation of Redmond, Wash.

In some embodiments, the pre-installed recommended applications 116 include application extensions or application add-ons that provide some additional functionality to another application. In some embodiments, the application extensions or application add-ons provide this additional functionality at least in part through web-based content.

In some embodiments, the pre-installed recommended applications 116 include one or more document templates for facilitating the creation of documents such as, but not limited to, word processing documents, spreadsheet documents, presentation documents, drawings documents, and collaboration documents. A template, as used herein, may be a style guide for a document. For instance, a word processing document template may include, but is not limited to including, formatting, styles, boilerplate text, headers, footers, macros, dictionaries, toolbars, and/or auto text entries. The document templates stored in the document may have one or more web application extensions or add-ons embedded within or attached thereto.

In some embodiments, one or more of the pre-installed recommended applications 116 are trial versions. In these embodiments, the full application may be downloaded after the user purchases the application.

The recommended applications 106 may be recommended broadly for every user of the application marketplace, or may be tuned to a specific user or group of users. In some embodiments, the recommended applications 106 are provided by the marketplace server computer 108 to the user device 102 on a periodic basis, such as weekly, daily, monthly, bi-monthly, or some other reoccurring time period. In some embodiments, new recommended applications are added to the pre-installed recommended applications 116 that are stored on the user device 102. In some embodiments, one or more new recommended applications replace one or more of the pre-installed recommended applications 116 up to and including replacing all of the pre-installed recommended applications 116 stored on the user device 102 at a given time. In some embodiments, a pre-installed recommended application that is used with some specified frequency remains on the user device 102, while a pre-installed recommended application that does not is automatically uninstalled. The uninstalled application then may be replaced with a new recommended application. In this manner, the pre-installed recommended applications 116 that are stored on the user device 102 are always fresh. In some embodiments, recommended applications are pre-installed based upon a maximum filespace allocation on the user device. In some embodiments, the recommend applications are pre-installed before the user ever downloads their first application.

As noted above, the recommended applications 106 may be tuned to a specific user. In some embodiments, the recommended applications 106 may take into account a user's context, download history, purchase history, application usage, the manufacturer of the user device 102, and/or other factors. For example, if a user is editing a document with pie charts, the recommended applications 106 may include advanced pie chart applications, templates for advanced pie charts, or alternative related solutions that rely on an application extension to provide advance pie chart functionality. Another, more precise example, is to make the recommended applications 106 based upon the types of templates that a user has previously used. For instance, a user that uses a template for creating infographics provides good context for recommending an infographics-based application to the user.

In some embodiments, the pre-installed recommended applications 116 or a subset thereof is stored in a specific location on the user device 102. In some embodiments, the specific location is a folder that is dedicated to the pre-installed recommended applications 116. In some embodiments, the specific location is a folder that is configured to store existing applications and the pre-installed recommended applications 116. In some embodiments, the specific is a “featured applications” folder or a “new for you” folder. In some embodiments, individual recommended applications are highlighted in some manner so that the user can distinguish which new recommended applications have been installed. In this manner, a user can navigate to the specified location to discover and immediately use the pre-installed recommended applications 116. It is contemplated that the user can move one or more of the pre-installed recommended applications 116 to another location. If a pre-installed recommended application is moved, a new recommended application may be automatically downloaded and installed as a replacement for that application.

A user may from time-to-time desire to uninstall one or more of the pre-installed recommended applications 116 (shown in the illustrated embodiment as uninstalled recommended application(s) 118). The uninstallation of a pre-installed recommended application 116 from the user device 102 may trigger the user device 102 to generate and send an application status notification 120 to the marketplace server computer 108 to notify the marketplace server computer 108 of the uninstallation. This may prompt the marketplace server computer 108 to send a new recommended application 106 to the user device 102 to replace the uninstalled recommended application 118. The marketplace server computer 108 may additionally or alternatively provide instructions to the user device 102 to uninstall one or more of the pre-installed recommended applications 116.

In some embodiments, a bundle of recommended applications is installed instead of installing applications one at a time. In some embodiments, one or more recommended applications are determined based upon which previous automatically installed recommended applications were used. In some embodiments, the recommended application 106 is updated automatically when a later version becomes available.

The application status notifications 120 may also be used by the user device 102 to inform the marketplace server computer 108 of a usage or non-usage of a pre-installed recommended application 116, of a request to unlock a paid version of a pre-installed recommended application 116, or for any other reason that may or may not trigger the marketplace server computer 108 to send a new recommended application 106 to the user device 102.

The marketplace server computer 108 is configured to execute a server operating system 122 and one or more application programs such as, in the illustrated embodiment, a marketplace server application 124, a transaction management application 126, an entitlement management application 128, and a recommendation engine application 130. The server operating system 122 is a computer program for controlling the operation of the marketplace server computer 108. The application programs are executable programs configured to execute on top of the server operating system 122 to provide various functionality described herein.

Although the applications 124, 126, 128, 130 are illustrated as being hosted on the marketplace server computer 108, in some implementations, these applications each reside on different servers (not shown) or are distributed over a plurality of servers. In some implementations, some other combination of the applications 124, 126, 128, 130 resides on the marketplace server computer 108 and/or one or more different servers (not shown). Accordingly, the illustrated embodiment should not be interpreted as being limited to a server that necessarily includes all of the illustrated applications 124, 126, 128, 130.

The marketplace server application 124 is a server application program configured to provide infrastructure for an application marketplace through which applications, and more particularly, the recommended applications 106 can be downloaded to the user device 102. The marketplace server application 124, in some embodiments, provides account creation and management tools to facilitate the creation and management of user and developer accounts. The marketplace server application 124, in some embodiments, is configured to communicate with a user account data store 132 for storing user accounts and associated user information such as user identification (“user ID”), password and/or other authentication credential(s), name, email address, mailing address, telephone number, user preferences, payment account information, favorites, application purchase history, application download history, previously recommended applications, and the like. Although the marketplace server application 124 is illustrated as residing on the marketplace server computer 108 with the applications 126, 128, 130, it should be understood that, in some implementations, the marketplace server computer 108 includes only the marketplace server application 124, or the marketplace server application 124 and one or more of the applications 126, 128, 130, but not all of these applications.

The marketplace server application 124, in some embodiments, facilitates, at least in part, an application approval process through which an application developer can submit an application for inclusion in the application marketplace and receive an indication of whether or not the application is accepted. The marketplace server application 124, in some embodiments, facilitates the submission of application updates and descriptions for applications, and the overall management of applications deployed within the application marketplace. Applications provided in the application marketplace are stored in an application store 134. In some embodiments, some or all of the aforementioned functionality is included in a separate marketplace developer portal application (not shown), which may operate on the marketplace server computer 108 and/or one or more other server computers (also not shown).

In some embodiments, the marketplace server application 124 is a server application program that is configured to deliver web site content associated with the application marketplace to the user device 102. In particular, the marketplace server application 124 may host a web site or a portion thereof, may receive requests for web pages of the web site from the user device 102, and may deliver the web pages to the user device 102 in response thereto. In some embodiments, the marketplace server application 124 provides a web-based version of the marketplace application 112 so that the application marketplace is accessible from any computer or device that has an Internet connection via a web browser, such as the web browser application 114, instead of the marketplace application 112 or similar application having to be installed thereon.

The transaction management application 126 is a server application program that is configured to manage transactions between the marketplace server computer 108 and other devices, such as the user device 102. In some embodiments, the transaction management application 126 is configured to process payments for marketplace content, issue refunds where appropriate, and/or provide pay-outs to developers for income earned through the sale of the developers' applications in the application marketplace. In some embodiments, the transaction management application 126 is configured to accept a proprietary currency that is useable within the application marketplace and may or may not be useable elsewhere. In some embodiments, the transaction management application 126 communicates with one or more credit card company computers, bank computers, or other financial institution computers to process payments and perform other operations described above. Although the transaction management application 126 is illustrated as residing on the marketplace server computer 108 with the applications 124, 128, 130, it should be understood that, in some implementations, the marketplace server computer 108 includes only the transaction management application 126 or the transaction application 126 and one or more of the applications 124, 128, 130, but not all of these applications.

The entitlement management application 128 is a server application program that is configured to manage entitlements for users of the application marketplace. In particular, the entitlement management application 128 is configured to communicate with an entitlement store 136 to create and maintain entitlement records for users of the application marketplace. The entitlement management application 128 can update an entitlement record for a user associated with the user device 102 to indicate the user's entitlement for the pre-installed recommended applications 116, including when the pre-installed recommended applications 116 are provided to the user device 102 as part of the recommended applications 106, and updating the entitlement record when one or more of the pre-installed recommended applications 116 are uninstalled.

Entitlements may include free entitlements, trial entitlements, purchase entitlements, and consumption-based entitlements. Free entitlements may be configured to provide full or reduced functionality as compared to paid entitlement counterparts. Trial entitlements allow a user to access an application with one or more restrictions for using the application. These restrictions include, but are not limited to, time restrictions, use restrictions, functionality restrictions, or some combination thereof. In some embodiments, the user is provided an option to purchase the application after expiration of the trial entitlement. Purchase entitlements may include multiple tiers, such as basic and premium. A premium purchase entitlement may provide additional functionality above and beyond the functionality provided with a basic purchase entitlement. Purchase entitlement may be subscription-based. Consumption-based entitlements allow a user to access an application a specific number of times. Moreover, entitlements may be configured to auto-renew.

Time restrictions can be used to restrict the amount of time an application can be used before a trial entitlement expires. In some embodiments, a time restriction is cumulative such that time using the application is added until a time limit is reached, at which point the trial entitlement may expire. In some embodiments, a time restriction is reset after the time limit is reached. In these embodiments, any changes to the application or a product thereof (e.g., a document created by using the application) may be reset or may be saved if the user purchases the application. In some embodiments, a time restriction is combined with a functionality restriction and/or a use restriction.

Use restrictions can be used to restrict the number of times an application can be used before a trial entitlement expires. Use restrictions can be used to restrict usage of an application to a certain number of users. For instance, a trial entitlement for an application may be acquired for a group of users, but a use restriction can limit the maximum number of users to, say, three users at a given time. In some embodiments, each use has a time limit or other time restriction associated therewith. In some embodiments, a use restriction is combined with a time restriction and/or a functionality restriction.

Functionality restrictions can be used to restrict the functionality of an application. For instance, a functionality restriction may restrict the functionality of an application to being viewable and printable but not editable. Other functionality restrictions are contemplated. In some embodiments, a functionality restriction is combined with a time restriction and/or a use restriction.

In some embodiments, if an entitlement for a recommended application expires, the recommended application might be replaced with a different recommended application. In some embodiments, the different recommended application is similar to the replaced recommended application. In some embodiments, the different recommended application has no similarity to the replaced recommended application.

The entitlement management application 128, in some embodiments, handles restrictions and instructs the user device 102 to which an entitlement has been sent to prompt a user to purchase an entitlement upon expiration of a trial entitlement. The entitlement management application 128 is configured to perform other entitlement management operations described herein. Although the entitlement management application 128 is illustrated as residing on the marketplace server computer 108 with the applications 124, 126, 130, it should be understood that, in some implementations, the marketplace server computer 108 includes only the entitlement management application 138 or the entitlement management application 138 and one or more of the applications 132, 134, 136, but not all of these applications.

The recommendation engine application 130 is a server application program that is configured to determine recommended applications for users of the application marketplace. In the illustrated embodiment, the recommendation engine application 130 determines the recommended applications 106 that are sent the user device 102.

The marketplace server computer 108 is illustrated as including the user account data store 132, the application data store 134, and the entitlement data store 136. The user account store 132 is configured to store user accounts as described above. Each user account may have a user profile associated therewith. A user profile includes, but is not limited to including, what applications are being used by the user, the type(s) of applications being used, historic usage such as how often and for what amount of time an application is used, what applications are not being used, and other information regarding the user's usage behavior of the recommended applications 106. In some embodiments, the usage behavior of other applications that are installed on the user device 102 other than the pre-installed recommended applications 116 is also stored in the user profile. The recommendation engine application 130, in some embodiments, communicates with the user account store 132 to obtain the usage behavior of applications and to use, at least in part, the usage behavior in making the determination of the recommended applications 106 to send to the user device 102.

In some embodiments, usage behavior includes tracking a user (e.g., using an anonymous user ID) who downloads application A and then later download application B to form a relationship between applications A & B. Thus, the act of acquiring an application can enable a suite of recommendations to be given. This can be further enhanced by profiling the user. In some embodiments, profiling the user is performed by using contextual clues (e.g., is the user joined to a domain and is the user's organization name set), and recent behavioral evidence (e.g., did the user recently insert a chart and/or what template searches did the user). In other embodiments, profiling the user is performed by prompting the user to explicitly self-declare certain aspects (e.g. I am a student, I work in healthcare, etc.).

The entitlement data store 136 is configured to store entitlements for applications, such as the applications stored in the application data store 134. The application data store 134 is configured to store applications. The user account data store 132, the application data store 134, and the entitlement data store 136 may be stored in a memory (not shown) of the marketplace server computer 108 or may be in communication with the marketplace server computer 108. In some embodiments, two or more of the data stores 132, 134, 136 are combined.

Although the marketplace server application 124, the transaction management application 126, the entitlement management 128, and the recommendation engine application 130 are illustrated as operating on the marketplace server computer 108, it is contemplated that these applications, separately or together in some combination, may operate on one or more other server computers (not shown). In some embodiments, two or more of the marketplace server application 124, the transaction management application 126, the entitlement management application 128, and the recommendation engine application 130 are combined.

It should be understood that some implementations of the operating environment 100 include multiple user devices 102, multiple networks 104, multiple marketplace server computers 108, multiple device operating systems 110, multiple marketplace applications 112, multiple web browser applications 114, multiple server operating systems 122, multiple marketplace server applications 124, multiple transaction management applications 126, multiple entitlement management applications 128, multiple management applications 128, multiple user account stores 132, multiple application stores 134, and/or multiple entitlement stores 136. Thus, the illustrated embodiments should be understood as being illustrative, and should not be construed as being limited in any way.

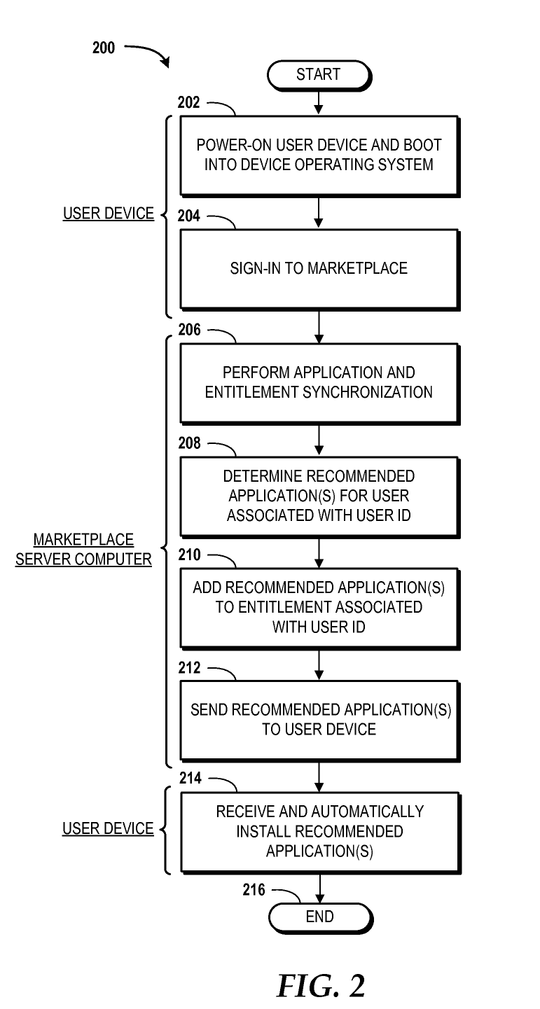

Turning now to FIG. 2, aspects of a method 200 for automatically installing recommended applications will be described, according to an illustrative embodiment. It should be understood that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, and/or performed simultaneously, without departing from the scope of the appended claims.

It also should be understood that the illustrated methods can be ended at any time and need not be performed in their respective entireties. Some or all operations of the methods, and/or substantially equivalent operations, can be performed by execution of computer-readable instructions included on a computer-storage media, as defined below. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, processor-based, programmable consumer electronics, combinations thereof, and the like.

Thus, it should be appreciated that the logical operations described herein are implemented (1) as a sequence of computer-implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules may be implemented in software, in firmware, in special purpose digital logic, and any combination thereof.

The method 200 will now be described with reference to FIG. 1. The method 200 begins at operation 202, wherein the user device 102 powers on and boots into the device operating system 108. From operation 202, the method 200 proceeds to operation 204, wherein the user device 102 signs-in to the application marketplace provided by the marketplace server computer 108. In some embodiments, the sign-in process includes a user inputting authentication credentials such as a user ID and password via an input mechanism into the user device 102, the user device 102 sending the authentication credentials to the marketplace server computer 108, and the marketplace server computer 108 signing in the user to the application marketplace upon approval of the authentication credentials. In some embodiments, the user previously have been signed in and their authentication credentials may be locally cached on the user device 102.

From operation 204, the method 200 proceeds to operation 206, wherein the marketplace server computer 108 performs application and entitlement synchronization. In particular, a call is made to the entitlement store 136 to determine for which applications the user has an entitlement. The user device 102 is then synchronized with the marketplace server computer 108 to ensure all applications and the latest versions thereof, along with the appropriate licenses are downloaded to the user device 102. For new devices that the user has never used before, this allows the user to, in effect, restore his or her new device to include the applications that the user had previously purchased and/or downloaded. It is contemplated that the user can elect to not download one or more up to all of the applications for which he or she has entitlements.

In addition to the above, at operation 206, a recommended applications portion is added to the user's entitlement. This ensures that the user's first experience on the user device 102 is to have one or more applications appearing to have been pre-installed (i.e., the pre-installed recommended applications 116). If a pre-installed recommended application 116 is free, then the user acquires an entitlement to use that application to the full extent available. For paid applications, however, the user may be provided with a trial version that the user can upgrade to a paid version at a later time. An entitlement for an application is not added if the user has previously owned the application.

From operation 206, the method 200 proceeds to operation 208, wherein the marketplace server computer 108 determines one or more recommended applications 106 for the user. At operation 210, the marketplace server computer 108 adds the recommended application(s) 106 to the entitlement associated with the user ID obtained during the sign-in process at operation 204. From operation 210, the method 200 proceeds to operation 212, wherein the marketplace server computer 108 sends the recommended application(s) 106 to the user device 102.

From operation 212, the method 200 proceeds to operation 214, wherein the user device 102 receives and automatically installs the recommended application(s) 106, which, as installed on the user device 102, are considered the pre-installed recommended application(s) 116. The method 200 then proceeds to operation 216, wherein the method 200 ends.

In some embodiments, depending on user privacy settings, the user may decide to grant newly installed applications the authority to examine certain user data (but perhaps not to send anything externally). This could enable the user to hit the ground running for certain apps, such as a “hot leads” application may require hours of processing of historical customer relationship management data to determine recommendations. For instance, users who grant the application the ability to automatically pre-process the data could try the application and instantly be productive, rather than run the application and return an hour or so later when pre-processing was complete.

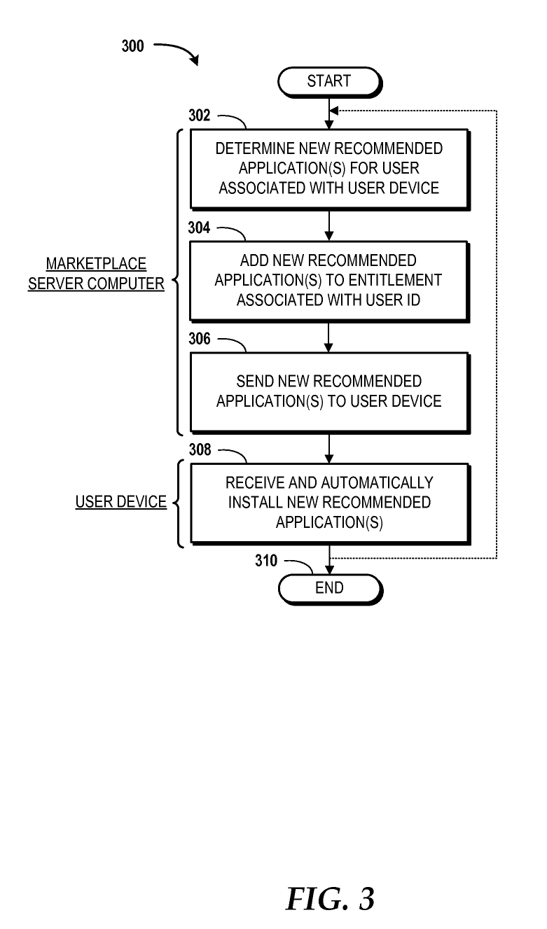

Turning now to FIG. 3, aspects of a method 300 for automatically installing recommended applications will be described, according to an illustrative embodiment. The method 300 begins and proceeds to operation 302, wherein the marketplace server computer determines one or more new recommended applications (also recommended application(s) 106 for convenience) for the user associated with the user device 102. From operation 302, the method 300 proceeds to operation 304, wherein the marketplace server computer 108 adds the recommended application(s) 106 to the entitlement associated with the user ID obtained during the sign-in process at operation 204. From operation 304, the method 300 proceeds to operation 306, wherein the marketplace server computer 108 sends the recommended application(s) 106 to the user device 102.

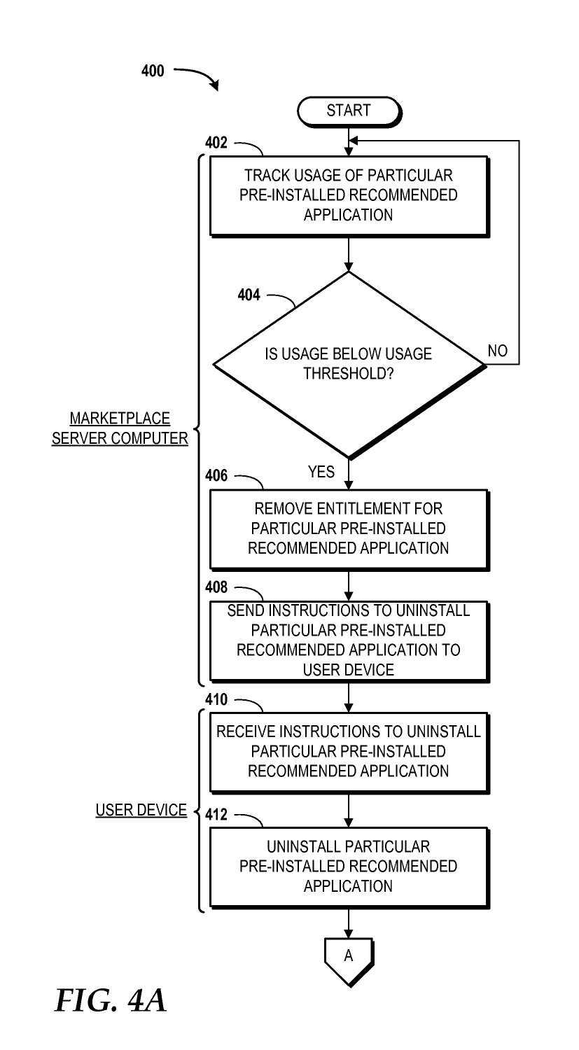

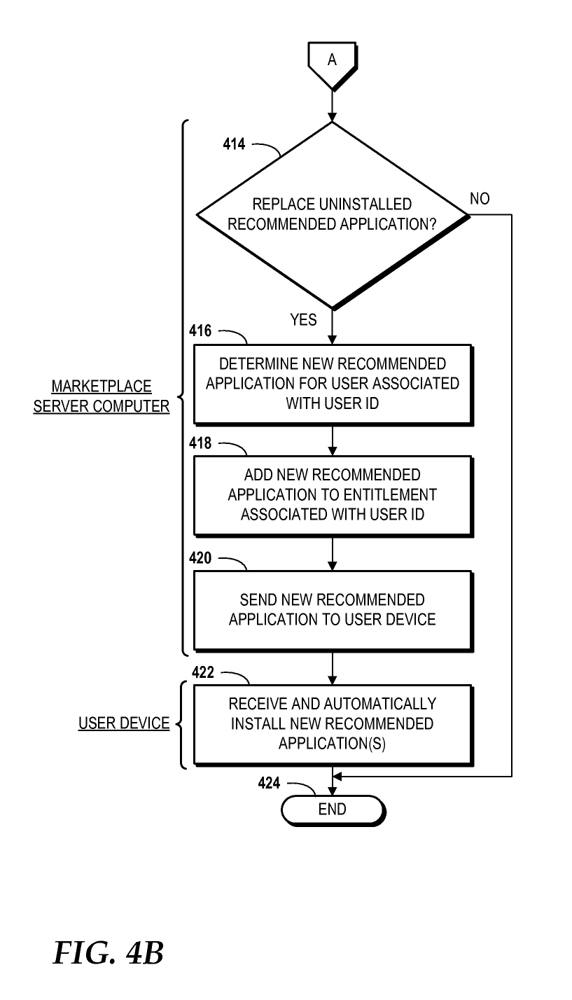

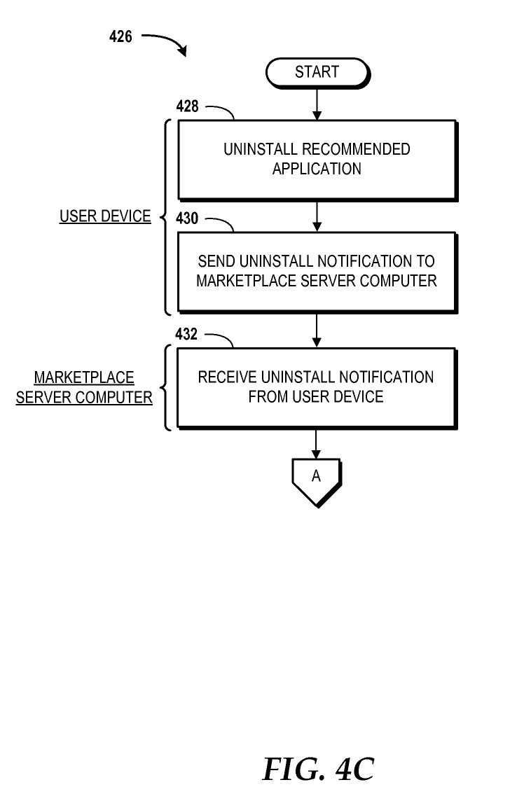

From operation 306, the method 300 proceeds to operation 308, wherein the user device 102 receives and automatically installs the recommended application(s) 106, which, as installed on the user device 102, are considered the pre-installed recommended application(s) 116. The method 300 may then return to operation 302, or proceed to operation 310, wherein the method 200 ends. The method 300 may return to the operation 302 if the marketplace server computer 108 is configured to provide the recommended application(s) 116 to the user device 102 on some periodic basis. As such, the method 300 may return to operation 302 on a daily, weekly, monthly, bi-monthly, or some other reoccurring time period so that the pre-installed recommended application(s) 116 stored on the user device 102 include fresh recommended applications. It is contemplated that one or more of the pre-installed recommended applications 116 may be uninstalled and be replaced by one or more new recommended applications, as will now be described in greater detail below with reference to FIG. 4.

Turning now to FIGS. 4A-4C, aspects of various methods for uninstalling and replacing recommended applications will be described, according to illustrative embodiments. Turning first to FIG. 4A, a method 400 begins and proceeds to operation 402, wherein the marketplace server computer 108 tracks the usage of a particular pre-installed recommended application of the pre-installed recommended applications 116. In some embodiments, the user device 102 is configured to provide feedback to the marketplace server computer 108 in regards to the usage of the pre-installed recommended applications 116. This feedback may be provided, for example, within the application status notification(s) 120 described herein above. In some embodiments, the marketplace server computer 108 queries the user device 102 for usage feedback. It is contemplated that the marketplace server computer 108 may track multiple pre-installed recommended applications, but the case in which the usage of one pre-installed recommended application is tracked is described for ease of explanation.

From operation 402, the method 400 proceeds to operation 404, wherein the marketplace server computer 108 determines if the usage of the particular pre-installed recommended application is below a usage threshold. The usage threshold defines a minimum usage of a pre-installed recommend application to cause the pre-installed recommended application to remain installed on the user device 102. If the usage of the particular pre-installed recommended application is not below the usage threshold, the method 400 returns to operation 402, wherein the marketplace server computer 108 continues to track the usage of the particular pre-installed recommended application. If the usage of the particular pre-installed recommended application falls below the usage threshold, the pre-installed recommended application can be removed from the user device 102. In this manner, the user need not manage the pre-installed recommended applications 116 that have been downloaded to and automatically installed on the user device 102.

In some embodiments, a time usage threshold is also used. For instance, a user might be given a week, a month, or some other time period within which to use a pre-installed recommended application before implementing the usage threshold.

In some embodiments, a negative reaction to certain pre-installed applications is marked for removal. This might be for any cause, such as, but not limited to, malware, privacy concerns, offensive content, or the application being heavily disliked for being a useless application. Thus, the device itself would periodically and automatically call to the marketplace to retrieve a ‘removal list’. This would add to the list formed at step 404, so there may be more applications to remove.

If the marketplace server computer 108 determines the usage of the particular pre-installed recommended application falls below the usage threshold, the method 400 proceeds to operation 406. At operation 406, the marketplace server computer 108 removes the entitlement for the particular pre-installed recommended application from the user's entitlement. From operation 406, the method 400 proceeds to operation 408, wherein the marketplace server computer 108 sends instructions to uninstall the particular pre-installed recommended application to the user device 102.

At operation 410, the user device 102 receives the instructions to uninstall the particular pre-installed recommended application. From operation 410, the method 400 proceeds to operation 412, wherein the user device 102 uninstalls the particular pre-installed recommended application. In some embodiments, the user device 102 informs the marketplace server computer 108 of the uninstallation of the particular pre-installed recommended application via an application status notification 120.

Turning now to FIG. 4B, the method 400 proceeds from operation 412 to operation 414. At operation 414, the marketplace server computer 108 determines whether or not to replace the uninstalled recommended application. If the marketplace server computer 108 determines to replace the uninstalled recommended application, the method 400 proceeds to operation 416, wherein the marketplace server computer 108 determines a new recommended application 106 for the user. From operation 416, the method 400 proceeds to operation 418, wherein the marketplace server computer 108 adds the new recommended application 106 to the user's entitlement. From operation 418, the method 400 proceeds to operation 420, wherein the marketplace server computer 108 sends the new recommended application 106 to the user device 102.

From operation 420, the method 400 proceeds to operation 422, wherein the user device 102 receives and automatically installs the new recommended application 106. The method 400 then proceeds operation 424, wherein the method 400 ends. If the marketplace server computer 108 determines, at operation 414, not to replace the uninstalled recommended application, the method 400 proceeds directly to operation 424 and the method 400 ends.

Turning now to FIG. 4C, in some embodiments, a user may desire to uninstall one or more of the pre-installed recommended applications 116. FIG. 4C illustrates a method 426 for facilitating the replacement of an uninstalled recommended application. The method 426 begins and proceeds to operation 428, wherein the user device 102 uninstalls one of the pre-installed recommended applications 116. From operation 428, the method 426 proceeds to operation 430, wherein the user device 102 sends an uninstall notification, such as in an application status notification 120, to the marketplace server computer 108. From operation 430, the method 426 proceeds to operation 432, wherein the marketplace server computer receives the uninstall notification from the user device 102.

In some embodiments, a more permanent uninstall of an unused recommendation. For an application that a user acquires themselves, a permanent record of the acquisition is typically stored, even if the user uninstalls the application. For a recommended application that was never used, the recommended application might be purged from the user's entitlement history.

Turning again to FIG. 4B, the method 426 proceeds from operation 432 to operation 414. At operation 414, the marketplace server computer 108 determines whether or not to replace the uninstalled recommended application. If the marketplace server computer 108 determines to replace the uninstalled recommended application, the method 400 proceeds to operation 416, wherein the marketplace server computer 108 determines a new recommended application 106 for the user. From operation 416, the method 400 proceeds to operation 418, wherein the marketplace server computer 108 adds the new recommended application 106 to the user's entitlement. From operation 418, the method 400 proceeds to operation 420, wherein the marketplace server computer 108 sends the new recommended application 106 to the user device 102.

From operation 420, the method 400 proceeds to operation 422, wherein the user device 102 receives and automatically installs the new recommended application 106. The method 400 then proceeds operation 424, wherein the method 400 ends. If the marketplace server computer 108 determines, at operation 414, not to replace the uninstalled recommended application, the method 400 proceeds directly to operation 424 and the method 400 ends.

Although the method 426 is described for uninstalling and replacing one of the pre-installed recommended applications 116, the method 426 also is applicable to uninstalling and replacing more than one of the pre-installed recommended applications 116.

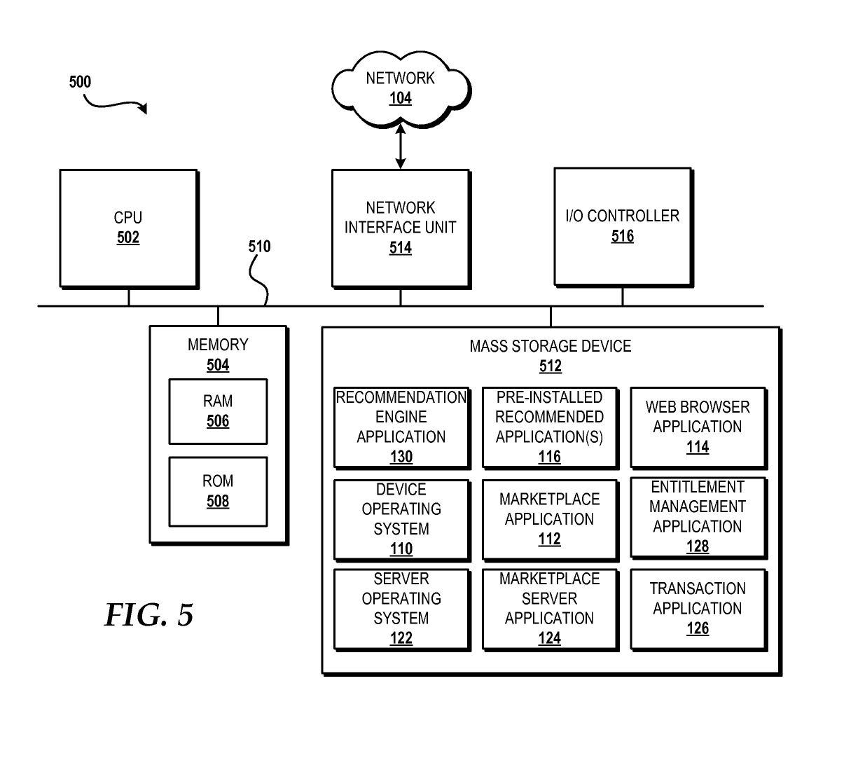

FIG. 5 illustrates an illustrative computer architecture 500 for a device capable of executing the software components described herein for automatically installing and removing recommended applications, among other aspects. Thus, the computer architecture 500 illustrated in FIG. 5 illustrates an architecture for a server computer, mobile phone, a PDA, a smart phone, a desktop computer, a netbook computer, a tablet computer, and/or a laptop computer. The computer architecture 500 may be utilized to execute any aspects of the software components presented herein.

In some embodiments, the user device 102 and/or the marketplace server computer 108 are configured in accordance with the computer architecture 500. As such, software components of the user device 102 and the marketplace server computer 108 are shown together within the computer architecture 500 for ease of illustration. It should be understood, however, that these software components may be and are likely to be implemented in separate computers, such as in a client/server configuration, or as standalone software components executing on one or both of the user device 102 and the marketplace server computer 108. It also should be understood that, although the user account data store 132, the application data store 134, and the entitlement data store 136 described above with reference to FIG. 1 are not illustrated, one or more of these data stores may also be included in the computer architecture 500 and/or the computer architecture 500 may be in communication with one or more of these data stores.

The computer architecture 500 illustrated in FIG. 5 includes a central processing unit 502 (“CPU”), a system memory 504, including a random access memory 506 (“RAM”) and a read-only memory (“ROM”) 508, and a system bus 510 that couples the memory 504 to the CPU 502. A basic input/output system containing the basic routines that help to transfer information between elements within the computer architecture 500, such as during startup, is stored in the ROM 508. The computer architecture 500 further includes a mass storage device 512 for storing the device operating system 110 or the server operating system 122, and one or more application programs including, but not limited to, the marketplace server application 124, the transaction application 126, the marketplace application 112, the entitlement management application 128, the recommendation engine application 130, the pre-installed recommended application(s) 116, and/or the web browser application 114.

The mass storage device 512 is connected to the CPU 502 through a mass storage controller (not shown) connected to the bus 510. The mass storage device 512 and its associated computer-readable media provide non-volatile storage for the computer architecture 500. Although the description of computer-readable media contained herein refers to a mass storage device, such as a hard disk or CD-ROM drive, it should be appreciated by those skilled in the art that computer-readable media can be any available computer storage media or communication media that can be accessed by the computer architecture 500.

Communication media includes computer-readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media

By way of example, and not limitation, computer storage media may include volatile and non-volatile, removable and non-removable media implemented in any method or technology for storage of information such as computer-readable instructions, data structures, program modules or other data. For example, computer media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer architecture 500. For purposes the claims, the phrase “computer storage medium” and variations thereof, does not include waves, signals, and/or other transitory and/or intangible communication media, per se.

According to various embodiments, the computer architecture 500 may operate in a networked environment using logical connections to remote computers through the network 104 and/or another network (not shown). The computer architecture 500 may connect to the network 104 through a network interface unit 514 connected to the bus 510. It should be appreciated that the network interface unit 514 also may be utilized to connect to other types of networks and remote computer systems. The computer architecture 500 also may include an input/output controller 516 for receiving and processing input from a number of other devices, including a keyboard, mouse, or electronic stylus (not shown in FIG. 5). Similarly, the input/output controller 516 may provide output to a display screen, a printer, or other type of output device (also not shown in FIG. 5).

It should be appreciated that the software components described herein may, when loaded into the CPU 502 and executed, transform the CPU 502 and the overall computer architecture 500 from a general-purpose computing system into a special-purpose computing system customized to facilitate the functionality presented herein. The CPU 502 may be constructed from any number of transistors or other discrete circuit elements, which may individually or collectively assume any number of states. More specifically, the CPU 502 may operate as a finite-state machine, in response to executable instructions contained within the software modules disclosed herein. These computer-executable instructions may transform the CPU 502 by specifying how the CPU 502 transitions between states, thereby transforming the transistors or other discrete hardware elements constituting the CPU 502.

Encoding the software modules presented herein also may transform the physical structure of the computer-readable media presented herein. The specific transformation of physical structure may depend on various factors, in different implementations of this description. Examples of such factors may include, but are not limited to, the technology used to implement the computer-readable media, whether the computer-readable media is characterized as primary or secondary storage, and the like. For example, if the computer-readable media is implemented as semiconductor-based memory, the software disclosed herein may be encoded on the computer-readable media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations take place in the computer architecture 500 in order to store and execute the software components presented herein. It also should be appreciated that the computer architecture 500 may include other types of computing devices, including hand-held computers, embedded computer systems, personal digital assistants, and other types of computing devices known to those skilled in the art. It is also contemplated that the computer architecture 500 may not include all of the components shown in FIG. 5, may include other components that are not explicitly shown in FIG. 5, or may utilize an architecture completely different than that shown in FIG. 5.

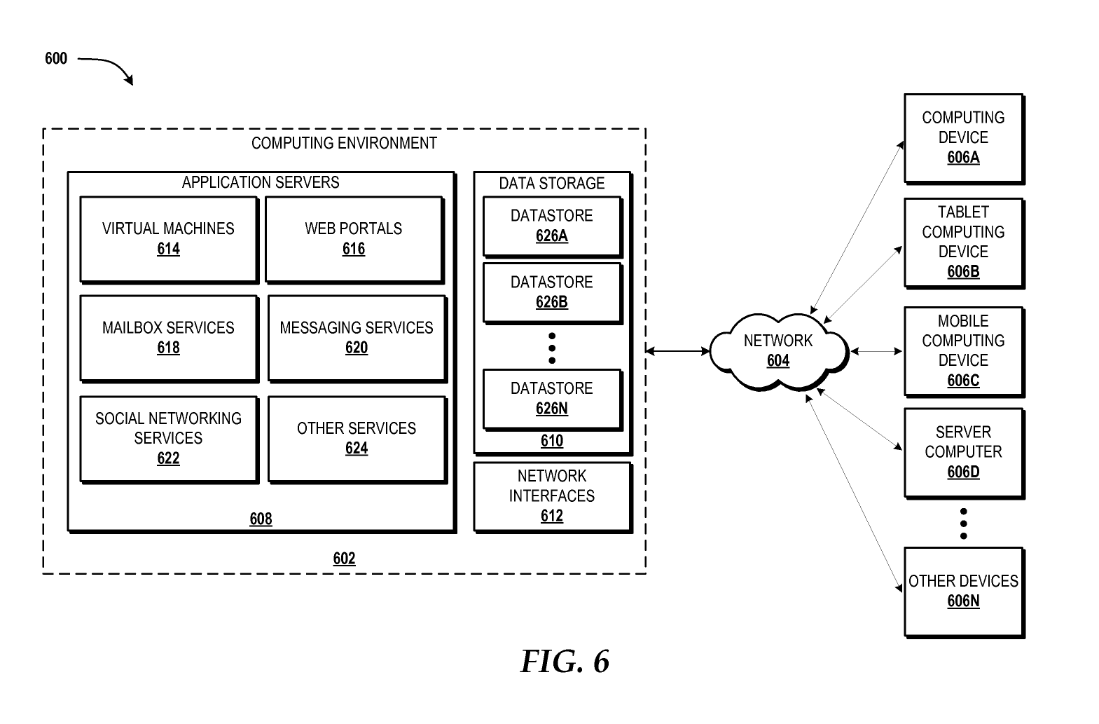

FIG. 6 illustrates an illustrative distributed computing environment 600 capable of executing the software components described herein for automatically installing and removing recommended applications, among other aspects. Thus, the distributed computing environment 600 illustrated in FIG. 6 can be utilized to execute any aspects of the software components presented herein. For example, the distributed computing environment 600 can be utilized to execute aspects of the marketplace server application 124, the transaction application 126, the marketplace application 112, the entitlement management application 128, the recommendation engine application 130, the pre-installed recommended application(s) 116, the web browser application 114, and/or other software components described herein.

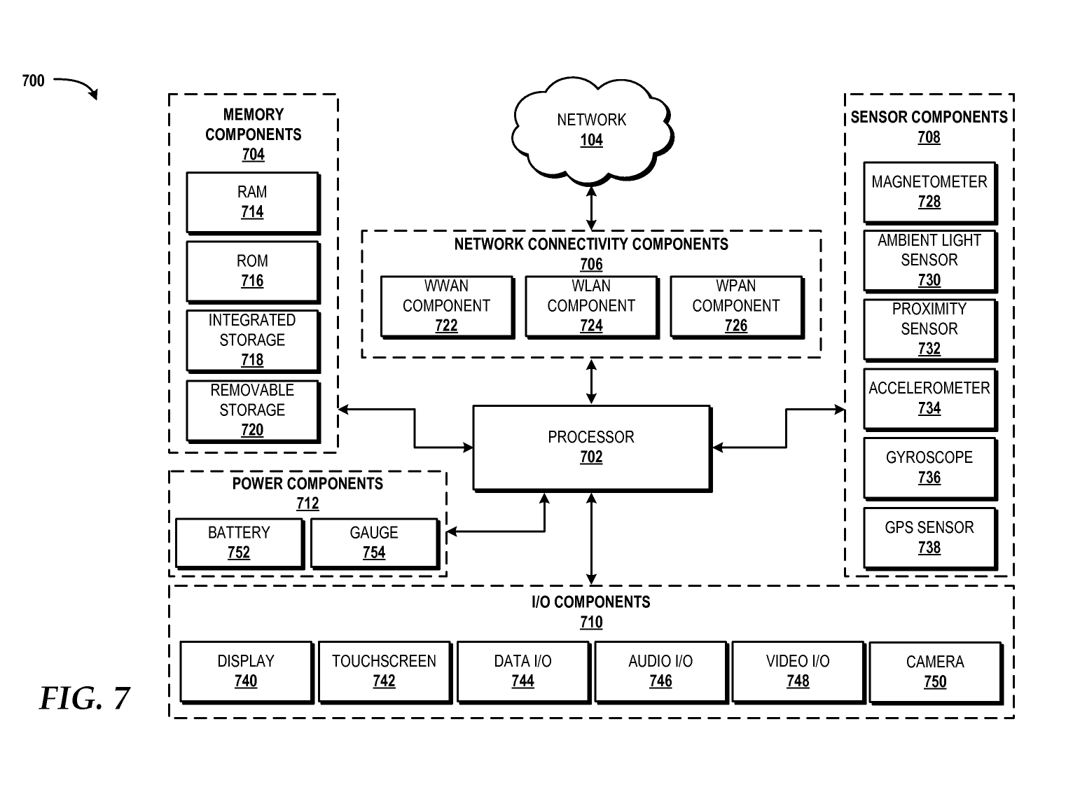

According to various implementations, the distributed computing environment 600 includes a computing environment 602 operating on, in communication with, or as part of the network 604. The network 604 may be or may include the network 104, described above with reference to FIG. 1. The network 604 also can include various access networks. One or more client devices 606A-606N (hereinafter referred to collectively and/or generically as “clients 606”) can communicate with the computing environment 602 via the network 604 and/or other connections (not illustrated in FIG. 6). In the illustrated embodiment, the clients 606 include a computing device 606A such as a laptop computer, a desktop computer, or other computing device; a slate or tablet computing device (“tablet computing device”) 606B; a mobile computing device 606C such as a mobile telephone, a smart phone, or other mobile computing device; a server computer 606D; and/or other devices 606N. It should be understood that any number of clients 606 can communicate with the computing environment 602. Two example computing architectures for the clients 606 are illustrated and described herein with reference to FIGS. 5 and 7. It should be understood that the illustrated clients 606 and computing architectures illustrated and described herein are illustrative, and should not be construed as being limited in any way.

In the illustrated embodiment, the computing environment 602 includes application servers 608, data storage 610, and one or more network interfaces 612. According to various implementations, the functionality of the application servers 608 can be provided by one or more server computers that are executing as part of, or in communication with, the network 604. The application servers 608 can host various services, virtual machines, portals, and/or other resources. In the illustrated embodiment, the application servers 608 host one or more virtual machines 614 for hosting applications or other functionality. According to various implementations, the virtual machines 614 host one or more applications and/or software modules for providing the functionality described herein for automatically installing and removing recommended applications, among other aspects. It should be understood that this embodiment is illustrative, and should not be construed as being limited in any way. The application servers 608 also host or provide access to one or more Web portals, link pages, Web sites, and/or other information (“Web portals”) 616.

According to various implementations, the application servers 608 also include one or more mailbox services 618 and one or more messaging services 620. The mailbox services 618 can include electronic mail (“email”) services. The mailbox services 618 also can include various personal information management (“PIM”) services including, but not limited to, calendar services, contact management services, collaboration services, and/or other services. The messaging services 620 can include, but are not limited to, instant messaging services, chat services, forum services, and/or other communication services.

The application servers 608 also can include one or more social networking services 622. The social networking services 622 can include various social networking services including, but not limited to, services for sharing or posting status updates, recommended applications, instant messages, links, photos, videos, and/or other information; services for commenting or displaying interest in articles, products, blogs, or other resources; and/or other services. In some embodiments, the social networking services 622 are provided by or include the FACEBOOK social networking service, the LINKEDIN professional networking service, the MYSPACE social networking service, the FOURSQUARE geographic networking service, the YAMMER office colleague networking service, and the like. In other embodiments, the social networking services 622 are provided by other services, sites, and/or providers that may or may not be explicitly known as social networking providers. For example, some web sites allow users to interact with one another via email, chat services, and/or other means during various activities and/or contexts such as reading published articles, commenting on goods or services, publishing, collaboration, gaming, and the like. Examples of such services include, but are not limited to, the WINDOWS LIVE service and the XBOX LIVE service from Microsoft Corporation in Redmond, Wash. Other services are possible and are contemplated.

The social networking services 622 also can include commenting, blogging, and/or micro blogging services. Examples of such services include, but are not limited to, the YELP commenting service, the KUDZU review service, the OFFICETALK enterprise micro blogging service, the TWITTER messaging service, the GOOGLE+ service, and/or other services. It should be appreciated that the above lists of services are not exhaustive and that numerous additional and/or alternative social networking services 622 are not mentioned herein for the sake of brevity. As such, the above embodiments are illustrative, and should not be construed as being limited in any way.

As shown in FIG. 6, the application servers 608 also can host other services, applications, portals, and/or other resources (“other resources”) 624. The other resources 624 can include, but are not limited to, the presentation application program. It thus can be appreciated that the computing environment 602 can provide integration of the concepts and technologies disclosed herein provided herein with various mailbox, messaging, social networking, and/or other services or resources.

As mentioned above, the computing environment 602 can include the data storage 610. According to various implementations, the functionality of the data storage 610 is provided by one or more databases operating on, or in communication with, the network 604. The functionality of the data storage 610 also can be provided by one or more server computers configured to host data for the computing environment 602. The data storage 610 can include, host, or provide one or more real or virtual datastores 626A-626N (hereinafter referred to collectively and/or generically as “datastores 626”). The datastores 626 are configured to host data used or created by the application servers 608 and/or other data. Although not illustrated in FIG. 6, the datastores 626 also can host or store applications, templates, documents, entitlements, user accounts, developer accounts, and the like.

The computing environment 602 can communicate with, or be accessed by, the network interfaces 612. The network interfaces 612 can include various types of network hardware and software for supporting communications between two or more computing devices including, but not limited to, the clients 606 and the application servers 608. It should be appreciated that the network interfaces 612 also may be utilized to connect to other types of networks and/or computer systems.

It should be understood that the distributed computing environment 600 described herein can provide any aspects of the software elements described herein with any number of virtual computing resources and/or other distributed computing functionality that can be configured to execute any aspects of the software components disclosed herein. According to various implementations of the concepts and technologies disclosed herein, the distributed computing environment 600 provides the software functionality described herein as a service to the clients 606. It should be understood that the clients 606 can include real or virtual machines including, but not limited to, server computers, web servers, personal computers, mobile computing devices, smart phones, and/or other devices. As such, various embodiments of the concepts and technologies disclosed herein enable any device configured to access the distributed computing environment 600 to utilize the functionality described herein for automatically installing and removing recommended applications, among other aspects.

Turning now to FIG. 7, an illustrative computing device architecture 700 for a computing device that is capable of executing various software components described herein for automatically installing and removing recommended applications, among other aspects. In some embodiments, the user device 102 and/or the marketplace server computer 108 uses the architecture 700 or some variation thereof. The computing device architecture 700 is applicable to computing devices that facilitate mobile computing due, in part, to form factor, wireless connectivity, and/or battery-powered operation. In some embodiments, the computing devices include, but are not limited to, mobile telephones such as smartphones, tablet devices, slate devices, portable video game devices, and the like. The computing device architecture 700 is applicable to any of the clients 606 shown in FIG. 6. Moreover, aspects of the computing device architecture 700 may be applicable to traditional desktop computers, portable computers (e.g., laptops, notebooks, ultra-portables, and netbooks), server computers, and other computer systems, such as described herein with reference to FIG. 5. For example, the single touch and multi-touch aspects disclosed herein below may be applied to desktop computers that utilize a touchscreen or some other touch-enabled device, such as a touch-enabled track pad or touch-enabled mouse.

The computing device architecture 700 illustrated in FIG. 7 includes a processor 702, memory components 704, network connectivity components 706, sensor components 708, input/output components 710, and power components 712. In the illustrated embodiment, the processor 702 is in communication with the memory components 704, the network connectivity components 706, the sensor components 708, the input/output (“I/O”) components 710, and the power components 712. Although no connections are shown between the individuals components illustrated in FIG. 7, the components can interact to carry out device functions. In some embodiments, the components are arranged so as to communicate via one or more busses (not shown).

The processor 702 includes a central processing unit (“CPU”) configured to process data, execute computer-executable instructions of one or more application programs, and communicate with other components of the computing device architecture 700 in order to perform various functionality described herein. The processor 702 may be utilized to execute aspects of the software components presented herein and, particularly, those that utilize, at least in part, a touch-enabled input.

In some embodiments, the processor 702 includes a graphics processing unit (“GPU”) configured to accelerate operations performed by the CPU, including, but not limited to, operations performed by executing general-purpose scientific and/or engineering computing applications, as well as graphics-intensive computing applications such as high resolution video (e.g., 720P, 1080P, and higher resolution), video games, three-dimensional (“3D”) modeling applications, and the like. In some embodiments, the processor 702 is configured to communicate with a discrete GPU (not shown). In any case, the CPU and GPU may be configured in accordance with a co-processing CPU/GPU computing model, wherein the sequential part of an application executes on the CPU and the computationally-intensive part is accelerated by the GPU.

In some embodiments, the processor 702 is, or is included in, a system-on-chip (“SoC”) along with one or more of the other components described herein below. For example, the SoC may include the processor 702, a GPU, one or more of the network connectivity components 706, and one or more of the sensor components 708. In some embodiments, the processor 702 is fabricated, in part, utilizing a package-on-package (“PoP”) integrated circuit packaging technique. The processor 702 may be a single core or multi-core processor.

The processor 702 may be created in accordance with the ARM architecture, available for license from ARM HOLDINGS of Cambridge, United Kingdom. Alternatively, the processor 702 may be created in accordance with the x86 architecture, such as is available from INTEL CORPORATION of Mountain View, Calif. and others. In some embodiments, the processor 702 is a SNAPDRAGON SoC, available from QUALCOMM of San Diego, Calif.; a TEGRA SoC, available from NVIDIA of Santa Clara, Calif.; a HUMMINGBIRD SoC, available from SAMSUNG of Seoul, South Korea; an Open Multimedia Application Platform (“OMAP”) SoC, available from TEXAS INSTRUMENTS of Dallas, Tex.; a customized version of any of the above SoCs; or a proprietary SoC.

The memory components 704 include a random access memory (“RAM”) 714, a read-only memory (“ROM”) 716, an integrated storage memory (“integrated storage”) 718, and a removable storage memory (“removable storage”) 720. In some embodiments, the RAM 714 or a portion thereof, the ROM 716 or a portion thereof, and/or some combination the RAM 714 and the ROM 716 is integrated in the processor 702. In some embodiments, the ROM 716 is configured to store a firmware, an operating system or a portion thereof (e.g., operating system kernel), and/or a bootloader to load an operating system kernel from the integrated storage 718 and/or the removable storage 720.

The integrated storage 718 can include a solid-state memory, a hard disk, or a combination of solid-state memory and a hard disk. The integrated storage 718 may be soldered or otherwise connected to a logic board upon which the processor 702 and other components described herein also may be connected. As such, the integrated storage 718 is integrated in the computing device. The integrated storage 718 is configured to store an operating system or portions thereof, application programs, data, and other software components described herein.

The removable storage 720 can include a solid-state memory, a hard disk, or a combination of solid-state memory and a hard disk. In some embodiments, the removable storage 720 is provided in lieu of the integrated storage 718. In other embodiments, the removable storage 720 is provided as additional optional storage. In some embodiments, the removable storage 720 is logically combined with the integrated storage 718 such that the total available storage is made available as a total combined storage capacity. In some embodiments, the total combined capacity of the integrated storage 718 and the removable storage 720 is shown to a user instead of separate storage capacities for the integrated storage 718 and the removable storage 720.

The removable storage 720 is configured to be inserted into a removable storage memory slot (not shown) or other mechanism by which the removable storage 720 is inserted and secured to facilitate a connection over which the removable storage 720 can communicate with other components of the computing device, such as the processor 702. The removable storage 720 may be embodied in various memory card formats including, but not limited to, PC card, CompactFlash card, memory stick, secure digital (“SD”), miniSD, microSD, universal integrated circuit card (“UICC”) (e.g., a subscriber identity module (“SIM”) or universal SIM (“USIM”)), a proprietary format, or the like.

It can be understood that one or more of the memory components 704 can store an operating system. According to various embodiments, the operating system includes, but is not limited to, SYMBIAN OS from SYMBIAN LIMITED, WINDOWS mobile OS from Microsoft Corporation of Redmond, Wash., WINDOWS phone OS from Microsoft Corporation, WINDOWS from Microsoft Corporation, PALM WEBOS from Hewlett-Packard Company of Palo Alto, Calif., BLACKBERRY OS from Research In Motion Limited of Waterloo, Ontario, Canada, IOS from Apple Inc. of Cupertino, Calif., and ANDROID OS from Google Inc. of Mountain View, Calif. Other operating systems are contemplated.

The network connectivity components 706 include a wireless wide area network component (“WWAN component”) 722, a wireless local area network component (“WLAN component”) 724, and a wireless personal area network component (“WPAN component”) 726. The network connectivity components 706 facilitate communications to and from the network 104 or another network, which may be a WWAN, a WLAN, or a WPAN. Although only the network 104 is illustrated, the network connectivity components 706 may facilitate simultaneous communication with multiple networks. For example, the network connectivity components 706 may facilitate simultaneous communications with multiple networks via one or more of a WWAN, a WLAN, or a WPAN.

The network 104 may be or may include a WWAN, such as a mobile telecommunications network utilizing one or more mobile telecommunications technologies to provide voice and/or data services to a computing device utilizing the computing device architecture 700 via the WWAN component 722. The mobile telecommunications technologies can include, but are not limited to, Global System for Mobile communications (“GSM”), Code Division Multiple Access (“CDMA”) ONE, CDMA2000, Universal Mobile Telecommunications System (“UMTS”), Long Term Evolution (“LTE”), and Worldwide Interoperability for Microwave Access (“WiMAX”). Moreover, the network 104 may utilize various channel access methods (which may or may not be used by the aforementioned standards) including, but not limited to, Time Division Multiple Access (“TDMA”), Frequency Division Multiple Access (“FDMA”), CDMA, wideband CDMA (“W-CDMA”), Orthogonal Frequency Division Multiplexing (“OFDM”), Space Division Multiple Access (“SDMA”), and the like. Data communications may be provided using General Packet Radio Service (“GPRS”), Enhanced Data rates for Global Evolution (“EDGE”), the High-Speed Packet Access (“HSPA”) protocol family including High-Speed Downlink Packet Access (“HSDPA”), Enhanced Uplink (“EUL”) or otherwise termed High-Speed Uplink Packet Access (“HSUPA”), Evolved HSPA (“HSPA+”), LTE, and various other current and future wireless data access standards. The network 104 may be configured to provide voice and/or data communications with any combination of the above technologies. The network 104 may be configured to or adapted to provide voice and/or data communications in accordance with future generation technologies.

In some embodiments, the WWAN component 722 is configured to provide dual- multi-mode connectivity to the network 104. For example, the WWAN component 722 may be configured to provide connectivity to the network 104, wherein the network 104 provides service via GSM and UMTS technologies, or via some other combination of technologies. Alternatively, multiple WWAN components 722 may be utilized to perform such functionality, and/or provide additional functionality to support other non-compatible technologies (i.e., incapable of being supported by a single WWAN component). The WWAN component 722 may facilitate similar connectivity to multiple networks (e.g., a UMTS network and an LTE network).

The network 104 may be a WLAN operating in accordance with one or more Institute of Electrical and Electronic Engineers (“IEEE”) 802.11 standards, such as IEEE 802.11a, 802.11b, 802.11g, 802.11n, and/or future 802.11 standard (referred to herein collectively as WI-FI). Draft 802.11 standards are also contemplated. In some embodiments, the WLAN is implemented utilizing one or more wireless WI-FI access points. In some embodiments, one or more of the wireless WI-FI access points are another computing device with connectivity to a WWAN that are functioning as a WI-FI hotspot. The WLAN component 724 is configured to connect to the network 104 via the WI-FI access points. Such connections may be secured via various encryption technologies including, but not limited, WI-FI Protected Access (“WPA”), WPA2, Wired Equivalent Privacy (“WEP”), and the like.

The network 104 may be a WPAN operating in accordance with Infrared Data Association (“IrDA”), BLUETOOTH, wireless Universal Serial Bus (“USB”), Z-Wave, ZIGBEE, or some other short-range wireless technology. In some embodiments, the WPAN component 726 is configured to facilitate communications with other devices, such as peripherals, computers, or other computing devices via the WPAN.

The sensor components 708 include a magnetometer 728, an ambient light sensor 730, a proximity sensor 732, an accelerometer 734, a gyroscope 736, and a Global Positioning System sensor (“GPS sensor”) 1338. It is contemplated that other sensors, such as, but not limited to, temperature sensors or shock detection sensors, also may be incorporated in the computing device architecture 1300.

The magnetometer 1328 is configured to measure the strength and direction of a magnetic field. In some embodiments the magnetometer 1328 provides measurements to a compass application program stored within one of the memory components 1304 in order to provide a user with accurate directions in a frame of reference including the cardinal directions, north, south, east, and west. Similar measurements may be provided to a navigation application program that includes a compass component. Other uses of measurements obtained by the magnetometer 1328 are contemplated.

The ambient light sensor 1330 is configured to measure ambient light. In some embodiments, the ambient light sensor 730 provides measurements to an application program stored within one the memory components 704 in order to automatically adjust the brightness of a display (described below) to compensate for low-light and high-light environments. Other uses of measurements obtained by the ambient light sensor 730 are contemplated.

The proximity sensor 732 is configured to detect the presence of an object or thing in proximity to the computing device without direct contact. In some embodiments, the proximity sensor 732 detects the presence of a user's body (e.g., the user's face) and provides this information to an application program stored within one of the memory components 704 that utilizes the proximity information to enable or disable some functionality of the computing device. For example, a telephone application program may automatically disable a touchscreen (described below) in response to receiving the proximity information so that the user's face does not inadvertently end a call or enable/disable other functionality within the telephone application program during the call. Other uses of proximity as detected by the proximity sensor 732 are contemplated.

The accelerometer 734 is configured to measure proper acceleration. In some embodiments, output from the accelerometer 734 is used by an application program as an input mechanism to control some functionality of the application program. For example, the application program may be a video game in which a character, a portion thereof, or an object is moved or otherwise manipulated in response to input received via the accelerometer 734. In some embodiments, output from the accelerometer 734 is provided to an application program for use in switching between landscape and portrait modes, calculating coordinate acceleration, or detecting a fall. Other uses of the accelerometer 734 are contemplated.

The gyroscope 736 is configured to measure and maintain orientation. In some embodiments, output from the gyroscope 736 is used by an application program as an input mechanism to control some functionality of the application program. For example, the gyroscope 736 can be used for accurate recognition of movement within a 3D environment of a video game application or some other application. In some embodiments, an application program utilizes output from the gyroscope 736 and the accelerometer 734 to enhance control of some functionality of the application program. Other uses of the gyroscope 736 are contemplated.

The GPS sensor 738 is configured to receive signals from GPS satellites for use in calculating a location. The location calculated by the GPS sensor 738 may be used by any application program that requires or benefits from location information. For example, the location calculated by the GPS sensor 738 may be used with a navigation application program to provide directions from the location to a destination or directions from the destination to the location. Moreover, the GPS sensor 738 may be used to provide location information to an external location-based service, such as E911 service. The GPS sensor 738 may obtain location information generated via WI-FI, WIMAX, and/or cellular triangulation techniques utilizing one or more of the network connectivity components 706 to aid the GPS sensor 738 in obtaining a location fix. The GPS sensor 738 may also be used in Assisted GPS (“A-GPS”) systems.

The I/O components 710 include a display 740, a touchscreen 742, a data I/O interface component (“data I/O”) 744, an audio I/O interface component (“audio I/O”) 746, a video I/O interface component (“video I/O”) 748, and a camera 750. In some embodiments, the display 740 and the touchscreen 742 are combined. In some embodiments two or more of the data I/O component 744, the audio I/O component 746, and the video I/O component 748 are combined. The I/O components 710 may include discrete processors configured to support the various interface described below, or may include processing functionality built-in to the processor 702.

The display 740 is an output device configured to present information in a visual form. In particular, the display 740 may present GUI elements, text, images, video, notifications, virtual buttons, virtual keyboards, messaging data, Internet content, device status, time, date, calendar data, preferences, map information, location information, and any other information that is capable of being presented in a visual form. In some embodiments, the display 740 is a liquid crystal display (“LCD”) utilizing any active or passive matrix technology and any backlighting technology (if used). In some embodiments, the display 740 is an organic light emitting diode (“OLED”) display. Other display types are contemplated.

The touchscreen 742 is an input device configured to detect the presence and location of a touch. The touchscreen 742 may be a resistive touchscreen, a capacitive touchscreen, a surface acoustic wave touchscreen, an infrared touchscreen, an optical imaging touchscreen, a dispersive signal touchscreen, an acoustic pulse recognition touchscreen, or may utilize any other touchscreen technology. In some embodiments, the touchscreen 742 is incorporated on top of the display 740 as a transparent layer to enable a user to use one or more touches to interact with objects or other information presented on the display 740. In other embodiments, the touchscreen 742 is a touch pad incorporated on a surface of the computing device that does not include the display 740. For example, the computing device may have a touchscreen incorporated on top of the display 740 and a touch pad on a surface opposite the display 740.

In some embodiments, the touchscreen 742 is a single-touch touchscreen. In other embodiments, the touchscreen 742 is a multi-touch touchscreen. In some embodiments, the touchscreen 742 is configured to detect discrete touches, single touch gestures, and/or multi-touch gestures. These are collectively referred to herein as gestures for convenience. Several gestures will now be described. It should be understood that these gestures are illustrative and are not intended to limit the scope of the appended claims. Moreover, the described gestures, additional gestures, and/or alternative gestures may be implemented in software for use with the touchscreen 742. As such, a developer may create gestures that are specific to a particular application.

In some embodiments, the touchscreen 742 supports a tap gesture in which a user taps the touchscreen 742 once on an item presented on the display 740. The tap gesture may be used for various reasons including, but not limited to, opening or launching whatever the user taps. In some embodiments, the touchscreen 742 supports a double tap gesture in which a user taps the touchscreen 742 twice on an item presented on the display 740. The double tap gesture may be used for various reasons including, but not limited to, zooming in or zooming out in stages. In some embodiments, the touchscreen 742 supports a tap and hold gesture in which a user taps the touchscreen 742 and maintains contact for at least a pre-defined time. The tap and hold gesture may be used for various reasons including, but not limited to, opening a context-specific menu.

In some embodiments, the touchscreen 742 supports a pan gesture in which a user places a finger on the touchscreen 742 and maintains contact with the touchscreen 742 while moving the finger on the touchscreen 742. The pan gesture may be used for various reasons including, but not limited to, moving through screens, images, or menus at a controlled rate. Multiple finger pan gestures are also contemplated. In some embodiments, the touchscreen 742 supports a flick gesture in which a user swipes a finger in the direction the user wants the screen to move. The flick gesture may be used for various reasons including, but not limited to, scrolling horizontally or vertically through menus or pages. In some embodiments, the touchscreen 742 supports a pinch and stretch gesture in which a user makes a pinching motion with two fingers (e.g., thumb and forefinger) on the touchscreen 742 or moves the two fingers apart. The pinch and stretch gesture may be used for various reasons including, but not limited to, zooming gradually in or out of a website, map, or picture.

Although the above gestures have been described with reference to the use one or more fingers for performing the gestures, other appendages such as toes or objects such as styluses may be used to interact with the touchscreen 742. As such, the above gestures should be understood as being illustrative and should not be construed as being limited in any way.

The data I/O interface component 744 is configured to facilitate input of data to the computing device and output of data from the computing device. In some embodiments, the data I/O interface component 744 includes a connector configured to provide wired connectivity between the computing device and a computer system, for example, for synchronization operation purposes. The connector may be a proprietary connector or a standardized connector such as USB, micro-USB, mini-USB, or the like. In some embodiments, the connector is a dock connector for docking the computing device with another device such as a docking station, audio device (e.g., a digital music player), or video device.

The audio I/O interface component 746 is configured to provide audio input and/or output capabilities to the computing device. In some embodiments, the audio I/O interface component 744 includes a microphone configured to collect audio signals. In some embodiments, the audio I/O interface component 744 includes a headphone jack configured to provide connectivity for headphones or other external speakers. In some embodiments, the audio I/O interface component 746 includes a speaker for the output of audio signals. In some embodiments, the audio I/O interface component 744 includes an optical audio cable out.

The video I/O interface component 748 is configured to provide video input and/or output capabilities to the computing device. In some embodiments, the video I/O interface component 748 includes a video connector configured to receive video as input from another device (e.g., a video media player such as a DVD or BLURAY player) or send video as output to another device (e.g., a monitor, a television, or some other external display). In some embodiments, the video I/O interface component 748 includes a High-Definition Multimedia Interface (“HDMI”), mini-HDMI, micro-HDMI, DisplayPort, or proprietary connector to input/output video content. In some embodiments, the video I/O interface component 748 or portions thereof is combined with the audio I/O interface component 746 or portions thereof.

The camera 750 can be configured to capture still images and/or video. The camera 750 may utilize a charge coupled device (“CCD”) or a complementary metal oxide semiconductor (“CMOS”) image sensor to capture images. In some embodiments, the camera 750 includes a flash to aid in taking pictures in low-light environments. Settings for the camera 750 may be implemented as hardware or software buttons.

Although not illustrated, one or more hardware buttons may also be included in the computing device architecture 700. The hardware buttons may be used for controlling some operational aspect of the computing device. The hardware buttons may be dedicated buttons or multi-use buttons. The hardware buttons may be mechanical or sensor-based.

The illustrated power components 712 include one or more batteries 752, which can be connected to a battery gauge 754. The batteries 752 may be rechargeable or disposable. Rechargeable battery types include, but are not limited to, lithium polymer, lithium ion, nickel cadmium, and nickel metal hydride. Each of the batteries 752 may be made of one or more cells.

The battery gauge 754 can be configured to measure battery parameters such as current, voltage, and temperature. In some embodiments, the battery gauge 754 is configured to measure the effect of a battery's discharge rate, temperature, age and other factors to predict remaining life within a certain percentage of error. In some embodiments, the battery gauge 754 provides measurements to an application program that is configured to utilize the measurements to present useful power management data to a user. Power management data may include one or more of a percentage of battery used, a percentage of battery remaining, a battery condition, a remaining time, a remaining capacity (e.g., in watt hours), a current draw, and a voltage.

The power components 712 may also include a power connector, which may be combined with one or more of the aforementioned I/O components 710. The power components 712 may interface with an external power system or charging equipment via a power I/O component 742.

Based on the foregoing, it should be appreciated that technologies for automatically installing and removing recommended applications have been disclosed herein. Although the subject matter presented herein has been described in language specific to computer structural features, methodological and transformative acts, specific computing machinery, and computer readable media, it is to be understood that the invention defined in the appended claims is not necessarily limited to the specific features, acts, or media described herein. Rather, the specific features, acts and mediums are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the present invention, which is set forth in the following claims.

We claim:

1. A computer-implemented method for automatically installing recommended applications on a user device, the computer-implemented method comprising performing computer-implemented operations for:
determining, utilizing a marketplace server computer, a recommended application for a user;
adding, utilizing the marketplace server computer, the recommended application to an entitlement associated with the user; and
sending, utilizing the marketplace server computer, the recommended application along with instructions to automatically install the recommended application to the user device.

2. The computer-implemented method of claim 1, wherein determining the recommended application for the user comprises determining the recommended application based upon an application recommendation for every user of an application marketplace provided by the marketplace server computer.

3. The computer-implemented method of claim 1, wherein determining the recommended application for the user comprises determining the recommended application based at least in part upon information specific to the user.

4. The computer-implemented method of claim 3, wherein the information specific to the user comprises at least one of the following: context information, application download history information, document template download history, application purchase history information, user profile information, or application usage information.

5. The computer-implemented method of claim 1, wherein determining the recommended application for the user comprises determining the recommended application based at least in part upon an application recommendation for a group of users of an application marketplace provided by the marketplace server computer, the user being part of the group of users.

6. The computer-implemented method of claim 1, further comprising:
determining, utilizing a marketplace server computer, a new recommended application for the user;
adding, utilizing the marketplace server computer, the new recommended application to the entitlement associated with the user; and
sending, utilizing the marketplace server computer, the new recommended application along with instructions to automatically install the new recommended application to the user device.

7. The computer-implemented method of claim 6, wherein the instructions to automatically install the new recommended application further comprise instructions to uninstall the recommended application such that the new recommended application replaces the recommended application on the user device.

8. The computer-implemented method of claim 1, further comprising:
tracking, utilizing the marketplace server computer, a usage of the recommended application through information communicated by the user device;
determining, utilizing the marketplace server computer, that the usage of the recommended application is below a usage threshold; and
in response to determining that the usage of the recommended application is below the usage threshold,
removing the recommended application from the entitlement associated with the user,
sending instructions to uninstall the recommended application to the user device, and
recording information regarding the usage of the recommended application being below the usage threshold so as to reduce a likelihood that one or more other users will be recommended the recommended application.

9. The computer-implemented method of claim 8, further comprising:
determining, utilizing the marketplace server computer, that the uninstalled recommended application should be replaced; and
in response to determining that the uninstalled recommended application should be replaced,
determining, utilizing a marketplace server computer, a new recommended application for the user,
adding, utilizing the marketplace server computer, the new recommended application to the entitlement associated with the user, and
sending, utilizing the marketplace server computer, the new recommended application along with instructions to automatically install the new recommended application to the user device.

10. The computer-implemented method of claim 1, further comprising:
receiving, utilizing the marketplace server computer, an uninstall notification from the user device;
in response to receiving the uninstall notification, determining that the uninstalled recommended application should be replaced; and
in response to determining that the uninstalled recommended application should be replaced,
determining, utilizing a marketplace server computer, a new recommended application for the user,
adding, utilizing the marketplace server computer, the new recommended application to the entitlement associated with the user, and
sending, utilizing the marketplace server computer, the new recommended application along with instructions to automatically install the new recommended application to the user device.

11. A marketplace server computer, comprising:
a processor; and
a memory in communication with the processor, the memory comprising computer-executable instructions that, when executed by the processor, cause the processor to
determine a recommended application for a user associated with a user device,
add the recommended application to an entitlement associated with the user, and to
send the recommended application along with instructions to automatically install the recommended application to the user device.

12. The marketplace server computer of claim 11, wherein the memory further comprises computer-executable instructions that, when executed by the processor, cause the processor to:
determine a new recommended application for the user,
add the new recommended application to the entitlement associated with the user, and to
send the new recommended application along with instructions to automatically install the new recommended application to the user device.

13. The marketplace server computer of claim 12, wherein the instructions to automatically install the new recommended application further comprise instructions to uninstall the recommended application such that the new recommended application replaces the recommended application on the user device, replacement of the recommended application being part of process of continual installation and removal of recommended applications.

14. The marketplace server computer of claim 11, wherein the memory further comprises computer-executable instructions that, when executed by the processor, cause the processor to:
track a usage of the recommended application through information communicated by the user device;
determine that the usage of the recommended application is below a usage threshold;
in response to determining that the usage of the recommended application is below the usage threshold,
remove the recommended application from the entitlement associated with the user,
send instructions to uninstall the recommended application to the user device, and
record information regarding the usage of the recommended application being below the usage threshold so as to reduce a likelihood that one or more other users will be recommended the recommended application.

15. The marketplace server computer of claim 14, wherein the memory further comprises computer-executable instructions that, when executed by the processor, cause the processor to:
determine that the uninstalled recommended application should be replaced; and
in response to determining that the uninstalled recommended application should be replaced,
determine a new recommended application for the user,
add the new recommended application to the entitlement associated with the user, and
send the new recommended application along with instructions to automatically install the new recommended application to the user device.

16. The marketplace server computer of claim 11, wherein the memory further comprises computer-executable instructions that, when executed by the processor, cause the processor to:
receive an uninstall notification from the user device;
in response to receiving the uninstall notification, determine that the uninstalled recommended application should be replaced; and
in response to determining that the uninstalled recommended application should be replaced,
determine a new recommended application for the user,
add the new recommended application to the entitlement associated with the user, and
send the new recommended application along with instructions to automatically install the new recommended application to the user device.

17. A computer storage medium having computer-readable instructions stored thereupon that, when executed by a computer, cause the computer to:
determine a plurality of recommended applications for a user associated with a user device;
add the plurality of recommended applications to an entitlement associated with the user;
send the plurality of recommended applications along with instructions to automatically install the plurality of recommended applications to the user device;
determine to remove a recommended application of the plurality of recommended applications from the user device;
remove the recommended application from the entitlement associated with the user;
send instructions to uninstall the recommended application to the user device;
determine to replace the recommended application with a new recommended application;
determine the new recommended application to replace the recommended application;
add the new recommended application to the entitlement associated with the user; and
send the new recommended application to the user device to replace the recommended application that was uninstalled from the user device per the instructions to uninstall received by the user device.

18. The computer storage medium of claim 17, wherein the instructions to determine to remove the recommended application comprise instructions to determine to remove the recommended application based upon a usage of the recommended application being below a usage threshold.

19. The computer storage medium of claim 17, wherein the instructions to determine the plurality of recommended applications for the user associated with the user device comprise instructions to determine the plurality of recommended applications based upon an application recommendation for every user of an application marketplace.

20. The computer storage medium of claim 17, wherein the instructions to determine the new recommended application to replace the recommended application comprise instructions to determine the new recommended application based at least in part upon information specific to the user, the information specific to the user comprising at least one of the following: context information, application download history information, document template download history, application purchase history information, user profile information, or application usage information.
